(19) United States
(12) Patent Application Publication
(10) Pub. No.: US 2025/0328152 A1
(43) Pub. Date: Oct. 23, 2025

(54) Transporting A Load

(71) Applicant: HTS Hydraulische Transportsysteme GmbH, Fellbach (DE)

(72) Inventors: Bastian Gross, Stuttgart (DE); Michael Koch, Fellbach (DE); Armin Stiegele, Fellbach (DE)

(21) Appl. No.: 19/077,632

(22) Filed: Mar. 12, 2025

(30) Foreign Application Priority Data
Mar. 14, 2024 (DE) 102024107257.1

(51) Int. Cl. G05D 1/695; B65G 35/06; B65G 43/10; G05D 105/20

(52) U.S. Cl. CPC G05D 1/695; B65G 35/06; B65G 43/10; G05D 2105/20

(57) ABSTRACT

The invention relates to the transport of a load with a transport system comprising a first driven transport chassis and a second driven transport chassis, wherein in a first driving manoeuvre the second transport chassis follows the first transport chassis, wherein after the end of the first driving manoeuvre and switching to a second driving manoeuvre an alignment of the second transport chassis takes place, wherein after the alignment the load is transported with the transport system in the second driving manoeuvre, wherein in the second driving manoeuvre the second transport chassis follows the first transport chassis, wherein expediently at least one of the, preferably both, transport chassis can be freely positioned under the load.

The invention relates to a method for transporting a load with a transport system. The invention further relates to a transport system for transporting a load. The invention further relates to a driven transport chassis for a transport system. The invention further relates to a driven transport chassis for carrying out a method described herein and/or which is provided for carrying out a method described herein.

In order to transport a load, especially a heavy one, a transport system with transport chassis can be provided. In order to transport the load over a non-linear path, different driving manoeuvres are usually carried out one after the other. A first driving manoeuvre can, for example, be cornering, followed by a second driving manoeuvre, for example driving straight ahead or another cornering. In order for the second driving manoeuvre to be successful, the transport chassis must be aligned after the first driving manoeuvre and before the second driving manoeuvre. For this purpose, the chassis are manually positioned relative to each other. However, this procedure is very complex. If the load is resting on the transport chassis, the transport chassis are usually visually concealed, such that the load is usually jacked up just to position the transport chassis. This procedure is complex.

It is therefore an object of the invention to provide an improved technology for transporting a load. This object is achieved by the subject matter of the independent claims. Dependent claims represent preferred embodiments.

A method for transporting a load with a transport system comprising a first driven transport chassis and a second driven transport chassis comprises the following method steps:
transporting the load with the transport system in a first driving manoeuvre, wherein in the first driving manoeuvre the second transport chassis follows the first transport chassis,
ending the first driving manoeuvre and switching to a second driving manoeuvre,
aligning the second transport chassis, wherein the second transport chassis is automatically positioned relative to the first transport chassis,
transporting the load with the transport system in the second driving manoeuvre, wherein in the second driving manoeuvre the second transport chassis follows the first transport chassis.

Preferably, the transport system comprises the first, the second transport chassis and the load. In particular, the first and/or the second transport chassis, in particular and/or further transport chassis, can be freely positioned and/or adjusted under the load. In particular, the transport system is free of a transport frame. In particular, a transport frame is provided to place the load and to provide fixed mounting points for the transport chassis. Preferably, the transport system does not comprise a transport frame.

“Follow” is to be understood, for example, as meaning that the first and second transport chassis, in particular, form a combination and, in particular, the second transport chassis follows the first transport chassis, for example, drives behind it. In particular, the first transport chassis is a master, and the second transport chassis is a slave, and/or the third and/or further transport chassis are the slaves. For example, the master specifies the direction of travel, wherein the slave or slaves follow the master. It may be expedient for the first transport chassis to communicate directly with the second transport chassis. It may be expedient for the transport chassis to communicate via a control unit, for example via an operating device.

For example, a “driving manoeuvre” means a driving mode. A driving mode is, for example, crab steering, all-wheel steering, straight-ahead driving, cornering, turning, pivoting, kingpin steering, or the like. A “driving manoeuvre” can also be understood as a part of a driving mode, for example a turn that is carried out incompletely, and in order to continue the turn, the chassis must be aligned, in particular corrected, such that after the turn has been continued, the turn can be carried out completely. In particular, “driving manoeuvre” can also be understood to mean cornering with different curve radii or the like. In particular, “driving manoeuvre” can also be understood to mean that an error occurs during the journey, in particular due to traction, for example due to grease, which can cause a drive wheel to spin, for example, wherein the chassis are aligned, in particular corrected, in order to continue the journey, wherein the second transport chassis is automatically positioned relative to the first transport chassis.

During alignment, the two transport chassis are preferably arranged at least partially, in particular completely, under the load. It is particularly preferred that the alignment be carried out under load, in particular the load does not have to be lifted. This simplifies positioning and realignment, for example when changing modes, and/or makes it error-free and/or at least reduces errors, particularly in the case of transport chassis concealed by the load, particularly without visual contact. It is preferable to position the transport chassis visually when positioning them for the first time. Preferably, no further visual control is carried out during further alignments, especially when changing modes. Preferably, each transport chassis is aligned individually, especially if the direction and/or position of an individual chassis is to be realigned.

The automatic positioning of the second transport chassis relative to the first transport chassis enables easy alignment. In particular, the load does not need to be lifted when transitioning from the first to the second driving manoeuvre. This makes transporting the load easier. It may be expedient for the load to be lifted, particularly if one and/or more of the transport chassis deviate. A “deviation” is a change in position and/or direction of the transport chassis such that it can no longer be corrected by the transport chassis alone.

Preferably, before the second driving manoeuvre, and in particular after the first driving manoeuvre, the second chassis is aligned relative to the first chassis, in particular manually. Preferably, after the alignment, in particular manual alignment, a straight-ahead travel, in particular with the load, is carried out. Preferably, when the two transport chassis are not travelling parallel, the second transport chassis is aligned relative to the first transport chassis, in particular until both transport chassis are travelling parallel. Preferably, after alignment, an intermediate reset, in particular an intermediate zeroing, is carried out for the rotary encoder of the transport chassis and/or for the rotary encoders of the transport chassis. It may be expedient that after the alignment, the intermediate reset, in particular the intermediate zeroing, of the transport system, in particular of an operating device of the transport system, in particular of the transport chassis, is carried out. It may be advantageous to dispense with the intermediate reset, especially the intermediate zeroing.

The second transport chassis advantageously provides feedback on the complete, in particular successful, alignment in particular after the second transport chassis has completely aligned itself relative to the first transport chassis. This confirms that the alignment is successful, such that the second manoeuvre can begin. Preferably, the second transport chassis provides feedback on the incomplete alignment after the second transport chassis has incompletely aligned itself relative to the first transport chassis and/or while the second transport chassis is aligning itself relative to the first transport chassis. This indicates that the alignment was unsuccessful and/or the alignment is currently in progress, in particular such that the alignment should continue and/or the second manoeuvre should not be started yet. The feedback is advantageously provided wirelessly, for example via radio, for example at 2.4 GHz.

Advantageously, feedback is provided, for example, to the first transport chassis. Feedback is advantageously provided to an operator of the transport system. Feedback is advantageously provided to an operating device, wherein the operating device advantageously provides feedback to an operator. Feedback is advantageously visual, acoustic, and/or haptic. In the case of visual feedback, for example, one and/or two status indicators, in particular blue, may light up, in particular continuously, when there is complete alignment. Advantageously, in the case of visual feedback, for example, one and/or two status indicators can flash, particularly blue, when there is incomplete alignment. The status indicator reports in particular the position of the second transport chassis 1′ in relation to the rotation position. Preferably, feedback is provided for each transport chassis, in particular to the operating device, wherein the operating device advantageously provides feedback to the operator for each transport chassis. Preferably, feedback is provided for each of the master transport chassis and for one or more of the slave transport chassis, in particular to the operating device, wherein the operating device advantageously provides feedback to the operator for each of the master transport chassis and for one or more of the slave transport chassis.

Preferably, before the first driving manoeuvre, the second chassis is aligned relative to the first chassis, in particular manually. Preferably, after the alignment, in particular manual alignment, a straight-ahead travel, in particular with the load, is carried out. Preferably, when the two transport chassis are not travelling parallel, the second transport chassis is aligned relative to the first transport chassis, in particular until both transport chassis are travelling parallel. Preferably, after alignment, a reset, in particular a zeroing, is carried out for the rotary encoder of the transport chassis and/or for the rotary encoders of the transport chassis. It may be expedient that after the alignment, the reset, in particular the zeroing, of the transport system, in particular of an operating device of the transport system, in particular of the transport chassis, is carried out.

The transport chassis advantageously move under the load before the first driving manoeuvre. Advantageously, the reset of the transport chassis, and/or each of the transport chassis, and/or the transport system, in particular a zeroing, is carried out. Preferably, after the reset, a straight-ahead travel, in particular with the load, is carried out. Preferably, when the two transport chassis are not travelling parallel, the second transport chassis is aligned relative to the first transport chassis, in particular until both transport chassis are travelling parallel. Preferably, after alignment, a further reset, in particular a further zeroing, is carried out for the rotary encoder of the transport chassis and/or for the rotary encoders of the transport chassis. It may be expedient that after the alignment, the further reset, in particular the further zeroing, of the transport system, in particular of an operating device of the transport system, in particular of the transport chassis, is carried out. It may be advantageous to dispense with the further reset, especially the further zeroing.

The first transport chassis expediently comprises a frame and a turntable operatively connected to the frame. The turntable is expediently designed to support the load to be transported. The turntable can be rotated relative to the frame. The first transport chassis expediently comprises a rotary encoder. The rotary encoder expediently detects the angle of rotation and/or the change in the angle of rotation of the turntable relative to the frame. The second transport chassis expediently comprises a frame and a turntable operatively connected to the frame. The turntable is expediently designed to support the load to be transported. The turntable can expediently be rotated relative to the frame. The second transport chassis expediently comprises a rotary encoder. The rotary encoder expediently detects the angle of rotation and/or the change in the angle of rotation of the turntable relative to the frame. The angle of rotation of the first transport chassis and/or the second transport chassis and/or the change in the angle of rotation of the first transport chassis and/or the second transport chassis is expediently used to align the second transport chassis. The alignment of the first and/or second transport chassis and/or the transport system is expediently carried out exclusively using the angle of rotation and/or the change in the angle of rotation and/or local data of the transport chassis. Examples of local data of the transport chassis are data that are directly and/or indirectly related to a motor of the transport chassis, such as the rotational speed of a load roller of the transport chassis, the rotational angle of the load roller, comparison of the rotational speed and/or the rotational angle of a plurality of load rollers, and/or the like. Advantageously, data, in particular the local data and/or the angle of rotation and/or changes in the angle of rotation, are exchanged between the transport chassis.

The position of the first and/or second transport chassis, and in particular the relative position of the first to the second transport chassis, is expediently indicated and/or measured via the rotary encoder of the first transport chassis and/or the rotary encoder of the second transport chassis.

Advantageously, the first transport chassis communicates wirelessly with the second transport chassis and/or with the further transport chassis, for example via radio, and/or via WLAN, and/or via mobile radio, or the like. In particular, a radio frequency can be about 2.4 GHz, for example.

Advantageously, the transport chassis communicate via a central computer, in particular a server, or the like.

The transport system preferably comprises an operating device, in particular a remote control. Preferably, the first transport chassis and/or the second transport chassis can be operated via the operating device. Preferably, both transport chassis can be operated via the operating device.

The second transport chassis expediently informs the operating device whether the second transport chassis has fully aligned itself relative to the first transport chassis, and/or whether the second transport chassis has incompletely aligned itself relative to the first transport chassis, and/or whether the second transport chassis is aligning itself relative to the first transport chassis. The operating device expediently outputs the message to an operator.

Advantageously, the transport system comprises a first operating device, in particular a first remote control, for the first transport chassis and a second operating device, in particular a second remote control, for the second transport chassis. Advantageously, the first operating device communicates with the second operating device, in particular wirelessly. Advantageously, the first transport chassis communicates with the second transport chassis, in particular there is direct communication between the first and second transport chassis. Advantageously, a first control system of the first transport chassis communicates with a second control system of the second transport chassis, in particular there is direct communication between the first and second control systems. Advantageously, a first communication unit of the first transport chassis communicates with a second communication unit of the second transport chassis, in particular there is direct communication between the first and second communication units.

Preferably, the operating device sends a command to align the second transport chassis to the second transport chassis. In particular, the operating device receives an input for alignment, for example by pressing a control button or by moving a joystick. The operating device preferably sends the command for aligning the second transport chassis to the second transport chassis until the second transport chassis is aligned. It may be expedient to keep the control button pressed or the joystick moved until the alignment is complete. In particular, if the control button or joystick is released before full alignment, a message may be displayed, in particular the status indicator may flash.

The transport system expediently comprises a third driven transport chassis, wherein the following method steps can expediently be carried out:
transporting the load with the transport system in a first driving manoeuvre, wherein in the first driving manoeuvre the second transport chassis and the third transport chassis follow the first transport chassis,
ending the first driving manoeuvre and switching to a second driving manoeuvre,
aligning the second transport chassis and the third transport chassis, wherein the second transport chassis and the third transport chassis are automatically positioned relative to the first transport chassis,
transporting the load with the transport system in the second driving manoeuvre, wherein in the second driving manoeuvre the second transport chassis and the third transport chassis follow the first transport chassis.

The transport chassis are advantageously identical in design. Advantageously, the transport chassis are of the same height, in particular they have the same overall height. Advantageously, the distance of the load to the ground is the same for the transport chassis. It may be expedient for the transport chassis to be constructed differently. It may be expedient for the transport chassis to be of different heights. Transport chassis having different load capacities are expediently combined.

The transport chassis, in particular each of the transport chassis, can advantageously be freely positioned under the load. This means that the transport chassis does not/do not have to assume a predefined position under the load. In particular, any load can be transported that way.

A transport system for transporting a load is configured to carry out a method described herein.

A driven transport chassis is provided for a transport system described herein. A driven transport chassis is provided for carrying out a method described herein. Preferably, the driven transport chassis comprises a rotary encoder.

It is understood that the features mentioned above and those to be explained below can be used not only in the combination specified in each case, but also in other combinations or on their own, without departing from the scope of the present invention.

Advantageous exemplary embodiments of the invention are described below with reference to the accompanying figures. In the drawing:

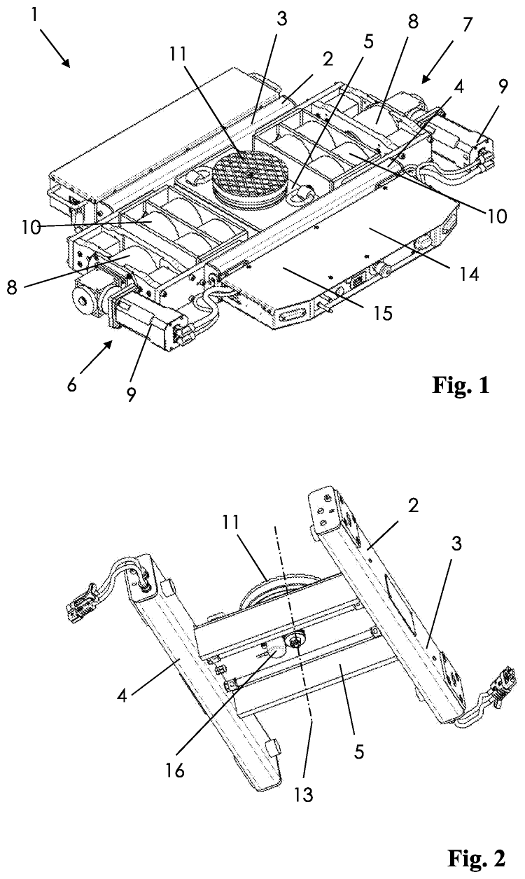

FIG. 1 is a perspective top view of a driven transport chassis,

FIG. 2 is a perspective bottom view of a detail, in particular a rotary encoder, of the driven transport chassis,

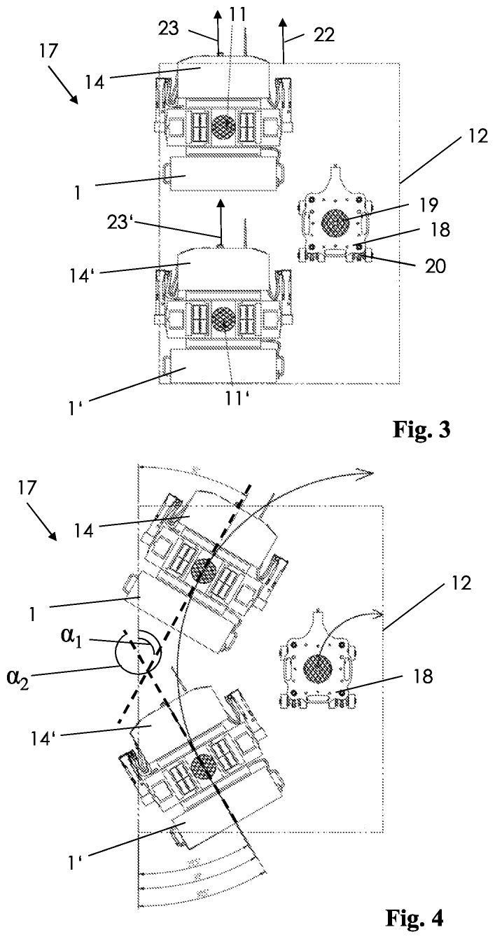

FIG. 3 is a schematic representation of a transport system in a straight-ahead mode and/or calibration mode,

FIG. 4 is a schematic representation of a transport system in all-wheel drive mode during a 30° curve,

FIG. 5 is a schematic representation of a transport system in an all-wheel drive mode in a 90° curve,

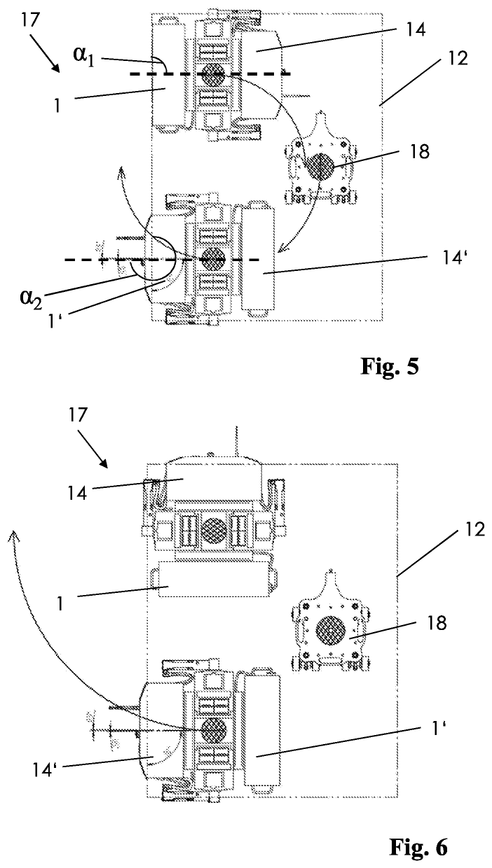

FIG. 6 is a schematic representation of a transport system in a pivot mode,

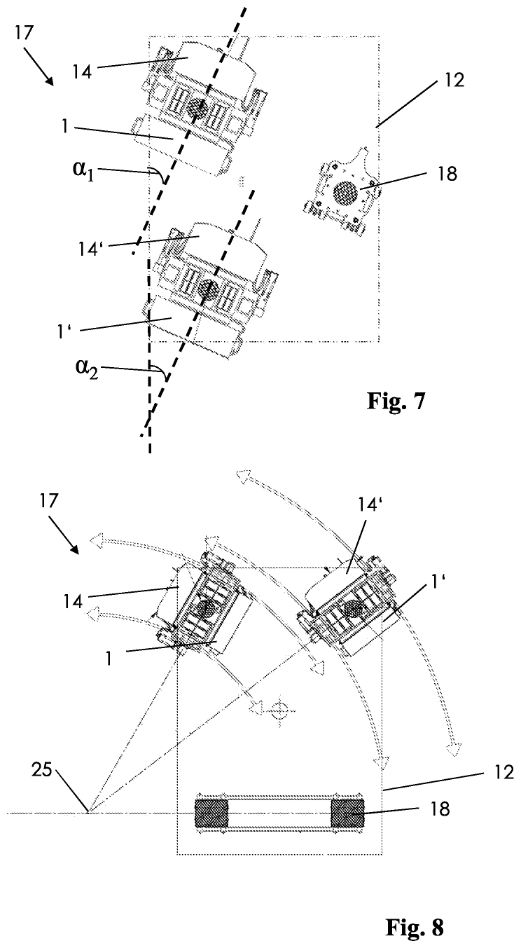

FIG. 7 is a schematic representation of a transport system in a crab steering mode,

FIG. 8 is a schematic representation of a transport system in a kingpin steering mode, and

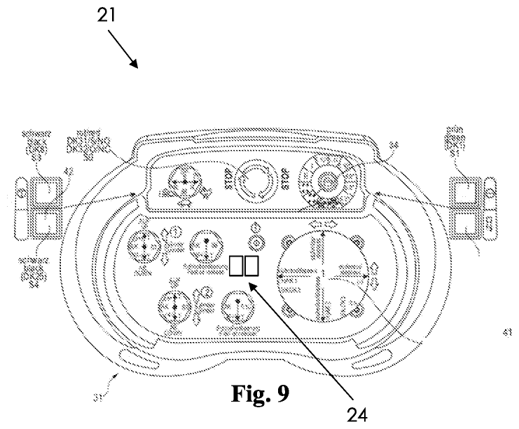

FIG. 9 is a schematic representation of an operating device.

In a first embodiment, FIG. 1 shows a driven transport chassis 1. The driven transport chassis 1 comprises a frame 2. In the exemplary embodiment, the frame 2 is designed in the shape of an “H”. The frame 2 comprises two longitudinal members 3, 4 and a cross member 5 connecting the longitudinal members. In the exemplary embodiment, two drive units 6, 7 are attached to the frame 2, in particular in a swinging manner. In the exemplary embodiment, the two drive units 6, 7 are largely identical in design, in particular the two drive units 6, 7 are designed in a symmetrical manner. In a further exemplary embodiment, it can be provided that the driven transport chassis 1 comprises only one drive unit 6, 7.

In the following, one of the two drive units 6, 7 will be described in more detail, wherein the description applies to both drive units 6, 7. In the claim, a distinction is made between “drive unit” and “further drive unit”. For ease of reading, the word “further” will be omitted below, wherein even if the word “further” is omitted, the following description applies to both drive rollers 6, 7. The same applies to the reference numerals.

The drive unit 6, 7 comprises a drive roller 8. The drive roller 8 is provided for transmitting power to a ground on which the driven transport chassis 1 can move. The drive unit 6, 7 comprises a motor, in the exemplary embodiment an electric motor 9, preferably a synchronous motor, in particular a three-phase synchronous motor. The power of the electric motor 9 is transferred to the ground via the drive roller 8.

The drive unit 6, 7 comprises at least one, in the exemplary embodiment four load rollers 10. The load rollers 10 are not driven. The load rollers 10 project a large part of the load onto the ground.

The driven transport chassis 1 comprises a turntable 11 shown in FIGS. 1 and 2. The turntable 11 is provided as a support point for a load 12 shown as an example in FIG. 3. As can be clearly seen in FIGS. 1 and 2, the turntable 11 is attached to the frame 2, in particular rotatably attached. The turntable 11 is attached centrally to the frame 2. In the exemplary embodiment, the frame 2 is designed as an “H”-shaped frame, wherein the turntable 11 is arranged in the centre, in particular in the geometric centre, and/or in particular in the centre of gravity, and/or in particular in the centre of symmetry, of the “H” frame. In the exemplary embodiment, the turntable 11 is attached to the cross member 5 of the frame 2. The turntable 11 is mounted on the frame 2 so that it can rotate about an axis of rotation 13. In a further embodiment, a lifting cylinder (not shown in the figures) can be operatively connected to the frame 2, in particular fastened to the frame 2. The load 12 can be expediently lifted using the lifting cylinder, wherein the transport chassis 1 can advantageously align itself when the load is lifted. Advantageously, the load 12 is lifted with the lifting cylinder, wherein subsequently, the load 12 is placed on a support. This advantageously allows the transport chassis 1 to move under the load and, if necessary, to assume a new position. Preferably, the load 12 is transported with a three-point support, in particular with a four-point support. The load 12 is advantageously transported in a cyclic production process. This, in particular due to the lifting cylinder, in particular due to an integrated stroke, creates the possibility, for example, of using a transport system and/or transport chassis with four-point support flexibly in a cyclic production. It may be expedient, particularly with the operatively connected lifting cylinder, for the frame 2 to be asymmetrical. In particular, the frame 2 may comprise a wider tube on one side than on the other side. For this purpose, installation space can be expediently provided, in particular installation space for the lifting cylinder, for a pump for the lifting cylinder (not shown in the figures), and/or for a tank for the lifting cylinder (not shown in the figures).

The driven transport chassis 1 comprises a control system 14 shown in FIG. 1. The control system 14 is attached to the frame 2, in the exemplary embodiment, for example, to one of the longitudinal members 4 of the frame 2. The control system 14 is used to control the driven transport chassis 1. The driven transport chassis 1 comprises a communication unit 15. The communication unit 15 is connected to the control system 14. The communication unit 15 can receive commands and/or send commands and/or receive and/or send messages.

The driven transport chassis 1 comprises a rotary encoder 16 shown in FIG. 2. The rotary encoder 16 is designed as an angular position encoder or angle sensor. The rotary encoder 16 detects the angle of rotation and/or the change in the angle of rotation of the turntable 11 relative to the frame 2. The recorded data, in particular the angle of rotation or the change in the angle of rotation, are sent to the control system 14 and further processed there if necessary. The recorded data, in particular the angle of rotation or the change in the angle of rotation, are optionally sent to the communication unit 15 and further processed there if necessary. For example, forwarded. In the exemplary embodiment, the rotary encoder 16 is attached to the frame 2 at the bottom, i.e. on the underside, i.e. on the side of the frame 2 facing the ground in the operating state. The rotary encoder 16 is attached to the cross member 5 of the frame 2. The rotary encoder 16 is operatively connected to the turntable 11. In a further exemplary embodiment, the rotary encoder 16 can also be arranged at the top. In a further exemplary embodiment, the rotary encoder 16 can also be installed with an integrated lift.

In the following, it will be explained with reference to FIGS. 4 to 9 how the load 12 can be transported.

A transport system 17 is provided for this purpose. In the exemplary embodiment, the transport system 17 comprises a first driven transport chassis 1 and a second driven transport chassis 1′. In a further exemplary embodiment, the transport system 17 can also have more than two driven transport chassis 1, 1′, for example three driven transport chassis, four driven transport chassis, six driven transport chassis, eight driven transport chassis, and the like. In the exemplary embodiment described below, the transport system 17 is intended to comprise two driven transport chassis 1, 1′. In particular, transferability to a plurality of transport chassis 1, 1′ should be ensured. In the exemplary embodiment, the two driven transport chassis 1, 1′ are of identical design. Reference numerals with and without “′” correspond to the same components, wherein the distinction is made by the driven transport chassis 1, 1′. The transport system 17 comprises a, in particular driveless, rotary chassis 18. The rotary chassis 18 comprises a support point, for example in the form of a support plate 19, in particular in the form of a rubber bellows, for the load 12. The rotary chassis 18 comprises load rollers 20.

The load 12 to be transported rests on the turntables 11, 11′ of the two driven transport chassis 1, 1′ and optionally on the support point, for example in the form of the support plate 19, of the optional rotary chassis 18. In a further exemplary embodiment, the load 12 to be transported rests on the turntables 11, 11′ of at least three transport chassis 1, 1′.

The transport system 17 comprises the control system 14 for controlling the first driven transport chassis 1. The transport system 17 comprises the control system 14′ for controlling the second driven transport chassis 1′. The first driven transport chassis 1 initially and substantially follows the direction of travel and/or driving manoeuvre specified by a user. Here, the control system 14 implements the driving commands of the user and/or the driving manoeuvre desired by the user by the control system 14 controlling the first driven transport chassis 1. The second control system 14′ controls the second driven transport chassis 1′ so that it follows the first driven transport chassis 1. Thus, both driven transport chassis 1, 1′ follow the direction of travel specified by the user and/or carry out the driving manoeuvre.

The second control system 14′ controls the second driven transport chassis 1′ depending on the first angle of rotation or the first change in the first angle of rotation of the first driven transport chassis 1 and depending on the second angle of rotation or the second change in the second angle of rotation of the second driven transport chassis 1′. In particular, the data on the angle of rotation and/or the change in the angle of rotation, in particular of both transport chassis 1, 1′, are used to carry out the driving manoeuvre. In a further exemplary embodiment, the second driven transport chassis 1′ is controlled directly via control data received via radio, wherein in particular the second control system 14′ is provided to align and/or correct and/or automatically position the second driven transport chassis 1′.

In the exemplary embodiment, the transport system 17 uses the control system 14 of the first transport chassis 1 or the control system 14′ of the second transport chassis 1′ for the overall control of the transport system. In a further exemplary embodiment, the control system 14, 14′ can be provided outside the transport chassis 1, 1′. In a further exemplary embodiment, only one control system 14, 14′ may be provided.

In a further exemplary embodiment, it can be provided that the control system 14, 4′ uses, in addition to the angle of rotation and/or the angles of rotation, further input variables for controlling the driven transport chassis 1, 1′ and/or each of the driven transport chassis 1, 1′. The additional input variables can be understood as, for example, a position datum and/or position data, which can in particular originate from GPS data. Input variables can also be understood as geometric data of the transport chassis and/or geometric data of the environment and/or geometric data of the load. Such geometric data are, for example, spatial dimensions, or the like.

The control system 14, 14′ of the first drive unit 6, 7 or the first drive units 6, 7 or the second drive unit 6′, 7′ or the second drive units 6′, 7′ can be controlled via an operating device 21 shown in FIG. 9. In the exemplary embodiment, the operating device 21 is designed in the form of a remote control. In a further exemplary embodiment, the operating system 21 can be wired.

In the following, it will be explained with reference to FIGS. 3 to 8 how the load 12 is transported using the transport system 17.

FIG. 3 shows a calibration mode or a straight-ahead driving mode. First, the load 12 is placed on the two driven transport chassis 1, 1′ and optionally on the rotary chassis 18. This allows the load 12 to be moved in all directions in the plane. The rotary chassis 18 is expediently arranged offset from the centre of the driven transport chassis 1, 1′.

The two driven transport chassis 1, 1′ are aligned parallel to a direction of travel 22 of the load 12, in particular manually. This means, as can be clearly seen in FIG. 3, that the straight-ahead directions 23, 23′ of the two driven transport chassis 1, 1′ are approximately parallel to each other. In addition, the straight-ahead travel directions of the two driven transport chassis 1, 1′ are approximately parallel to the desired straight-ahead direction of travel 22 of the load 12.

After the alignment, in particular manual alignment, a straight-ahead travel, in particular with the load 12, is carried out. If the two transport chassis 1, 1′ do not travel parallel, the second transport chassis 1′is aligned relative to the first transport chassis 1. Advantageously, the alignment is done automatically. In particular, the second transport chassis 1′ is aligned until both transport chassis 1, 1′ travel parallel. After alignment, the rotary encoders 16, 16′ are calibrated, in particular zeroed. The transport system 17 is now controllable and/or ready for driving manoeuvres.

The second transport chassis 1′ particularly preferably provides feedback on the complete alignment after the second transport chassis 1′ has completely aligned itself relative to the first transport chassis 1, in particular after the alignment of the second transport chassis 1′. Further particularly preferably, the second transport chassis 1′ provides feedback on the incomplete alignment after the second transport chassis 1′ has incompletely aligned itself relative to the first transport chassis 1 and/or while the second transport chassis 1′ is aligning itself relative to the first transport chassis 1. Such feedback can be provided wirelessly, for example via radio. The feedback can be sent to the first transport chassis 1, to the operator, and/or to the operating device 21 shown in FIG. 9. The operating device 21 can advantageously comprise a status indicator 24. The status indicator 24 can, for example, comprise two, in particular blue, LEDs. In the case of complete alignment, for example, one and/or two status indicators 24 may light up, in particular blue, in particular continuously. In the case of visual feedback, for example, the one and/or two status indicators 24 can advantageously flash, particularly blue, when there is incomplete alignment.

The control of the transport system 17, in particular of the two driven transport chassis 1, 1′, is preferably carried out via the operating device 21. The operator specifies via the operating device 21, for example, that the second transport chassis 1′ should be aligned relative to the first transport chassis 1. To do this, the operator can operate a button and/or operating element on the operating device 21. Preferably, the operator must press the button and/or the operating element until the second transport chassis 1′ is fully aligned. The operator receives a message via the status indicator 24 as soon as the second transport chassis 1′ is fully aligned and/or whether it is aligning itself straight and/or whether it is incompletely aligned.

The operator uses the operating device 21 to specify, for example, the desired direction of travel and/or the desired driving mode and/or the desired driving manoeuvre. The desired signals are then sent to the control systems 14, 14′. The first driven transport chassis 1 is controlled by the first control system 14. The second driven transport chassis 1′is controlled with the second control system 14′, preferably depending on the first angle of rotation or the first change in the first angle of rotation of the first driven transport system 1 and depending on the second angle of rotation or the second change in the second angle of rotation of the second driven transport system. The user only has to specify a direction of travel and/or a driving manoeuvre and/or a driving mode on the operating device 21. The control systems 14, 14′ then calculate the individual directions of travel of the individual driven transport chassis 1, 1′ depending on the angle of rotation such that the direction of travel of the load 12 corresponds to the desired direction of travel of the operator.

In particular, through the use of three-phase synchronous motors 9 and associated controllers, the target and actual speeds are almost the same. This makes it possible, particularly in combination with the rotary encoders 16, 16′, for the two or more driven transport systems 1, 1′ to be controlled via an operating device 21 and, in particular, to be driven synchronously.

Of particular interest to the operator is the alignment of the second transport chassis 1′, wherein the second transport chassis 1′ is automatically positioned relative to the first transport chassis 1. That way, for example, the load can be transported with the transport system 17 in a first driving manoeuvre, wherein in the first driving manoeuvre the second transport chassis 1′ follows the first transport chassis 1. After the first driving manoeuvre has ended, for example because the first driving manoeuvre has been completed or due to a command from the operator, the system switches to a second driving manoeuvre. Before the start of the second driving manoeuvre, the second transport chassis 1′ is aligned, wherein the second transport chassis 1′ is automatically positioned relative to the first transport chassis 1. Manual intervention by the operator is not required. After alignment, the load is transported with the transport system 17 in the second driving manoeuvre, wherein in the second driving manoeuvre the second transport chassis 1′ follows the first transport chassis 1.

In the following, further driving maneuvers and/or driving modes, in addition to the straight-ahead driving shown in FIG. 3, will be explained. The driving manoeuvres and/or driving modes can be arranged in any order, with the second transport chassis 1′ preferably being aligned relative to the first transport chassis 1 between two driving manoeuvres and/or driving modes.

FIG. 3 shows, in addition to the calibration mode, in which the two driven transport chassis 1, 1′ are stationary, the straight-ahead travel mode, in which the two driven transport chassis 1, 1′ travel straight ahead.

FIGS. 4 and 5 show an all-wheel drive mode, i.e. in particular cornering. During the movement, the two driven transport chassis 1, 1′ must in particular steer exactly in a mirror image to the horizontal and in particular maintain their position relative to the load. The two rotary encoders 16, 16′ determine the angular position of the two driven transport chassis 1, 1′ relative to the load 12. The control systems 14, 14′ control the first and second driven transport chassis 1, 1′in an all-wheel drive mode, in particular when cornering, such that the first angle of rotation al of the first driven transport chassis 1 and the second angle of rotation α2 of the second driven transport chassis 1′ are set in such a way that the second angle of rotation α2 is approximately 360°, in particular with a tolerance of approximately +/−1.5°, less the first angle of rotation α1, and in particular that the second transport chassis 1′ follows the track of the first transport chassis 1.

In a further exemplary embodiment, the control system 14′ of the second driven transport chassis 1′ in an all-wheel drive mode, in particular when cornering, controls the second driven transport chassis 1′ such that the second angle of rotation α2 is approximately 360°, in particular with a tolerance of approximately +/−1.5°, less the first angle of rotation α1, and in particular that the second transport chassis 1′ follows the track of the first transport chassis (1).

In FIG. 4, a first angle of rotation α1 of approximately 30° and a second angle of rotation α2 of approximately 330° are shown, in FIG. 5, a first angle of rotation α1 of approximately 90° and a second angle of rotation α2 of approximately 270° are shown. The driveless rotary chassis 18 follows the movements of the two driven transport chassis 1, 1′.

FIG. 6 shows a pivot mode, i.e. in particular a rotational movement. The control systems 14, 14′ control the first and second driven transport chassis 1, 1′ such that the first driven transport chassis 1 is stationary and the second driven transport chassis 1′ is moving. The load 12 is rotated about the first axis of rotation 13 of the first turntable 11 by aligning the second driven transport chassis 1′ relative to the first driven transport chassis 1 such that the amount of the difference between the second angle of rotation and the first angle of rotation is approximately 90°, in particular with a tolerance of approximately +/−1.5°. Advantageously, the pivot mode shown in FIG. 7 can also be carried out in such a way that the second driven transport chassis 1′is stationary and the first driven transport chassis 1 is moving. The load 12 is rotated about the second axis of rotation 13′ of the second turntable 11′ by aligning the first driven transport chassis 1 relative to the second driven transport chassis 1′ such that the amount of the difference between the first angle of rotation and the second angle of rotation is approximately 90°, in particular with a tolerance of approximately +/−1.5°.

In a further exemplary embodiment, the control system 14′ of the second driven transport chassis 1′ controls the second driven transport chassis 1′ in a pivot mode, in particular during a rotary travel, such that the second self-propelled transport chassis 1′ moves, wherein the first self-propelled transport chassis 1 is stationary, and that the load 12 is rotated about the first axis of rotation 13 of the first turntable 11 by aligning the second driven transport chassis 1′ relative to the first driven transport chassis 1 in such a way that the amount of the difference between the second angle of rotation and the first angle of rotation is approximately 90°, in particular with a tolerance of approximately +/−1.5°.

FIG. 7 shows a crab steering mode, i.e. in particular a diagonal drive. The control systems 14, 14′ control the first and the second driven transport chassis 1, 1′ such that the first angle of rotation α1 of the first driven transport chassis 1 and the second angle of rotation α2 of the second driven transport chassis 1′ are set such that they are approximately equal, in particular with a tolerance of approximately +/−1.5°, and in particular that the track of the second transport chassis 1′ runs parallel to the track of the first transport chassis 1. The load 12 can be moved “transversely”, i.e. in a translational movement.

In a further exemplary embodiment, the control system 14′ of the second driven transport chassis 1′ controls the second driven transport chassis 1′ in a crab steering mode, in particular during inclined travel, such that the first angle of rotation al and the second angle of rotation α2 are approximately the same, in particular with a tolerance of approximately +/−1.5°, and in particular that the track of the second transport chassis 1′ runs parallel to the track of the first transport chassis 1.

FIG. 8 shows a kingpin steering module, i.e. in particular cornering. The control systems 14, 14′ control the first and the second driven transport chassis 1, 1′ such that the load 12 is rotated about a pivot point 5, wherein the control systems 14, 14′ control in such a way that the first angle of rotation al of the first driven transport chassis 1 and the second angle of rotation α2 of the second driven transport chassis 1′ are set such that the first axis of rotation 13 of the first turntable 11 and the second axis of rotation 13′ of the second turntable 11′ each rotate about the pivot point 25, in particular that the first distance of the first axis of rotation 13 from the pivot point 25 is approximately constant, in particular that the second distance of the second axis of rotation 13′ from the pivot point 25 is approximately constant, and in particular that the first distance is approximately unequal to the second distance.

In a further exemplary embodiment, the control system 14′ of the second driven transport chassis 1′ in a kingpin steering module, in particular when cornering, controls the second driven transport chassis 1′ such that the load 12 is rotated about a pivot point 25, wherein the control system 14′ of the first driven transport chassis 1 and the control system 14′ of the second driven transport chassis 1′ control in such a way that the first angle of rotation 1 of the first driven transport chassis 1 and the second angle of rotation α2 of the second driven transport chassis 1′ are set in such a way that the first axis of rotation 13 of the first turntable 11 and the second axis of rotation 13′ of the second turntable 11′ each rotate about the pivot point 25, in particular that the first distance of the first axis of rotation 13 from the pivot point 25 is approximately constant, in particular that the second distance of the second axis of rotation 13′ from the pivot point 25 is approximately constant, and in particular that the first distance is approximately unequal to the second distance. In a further exemplary embodiment, the transport system 17 comprises four, six, eight, or more than eight transport chassis 1, 1′.

FIG. 9 shows an example of the operating device 21 in the form of a remote control. The user can control the two driven transport chassis 1, 1′ via the operating device 21 and, in particular, specify the desired driving manoeuvres, i.e. the desired direction of travel, for the load 12. The communication between the remote control and/or the transport chassis 1, 1′ is advantageously wireless, for example via radio. The operating device 21 comprises an input apparatus to specify the driving manoeuvres and/or driving modes and/or the orientation. The operating device 21 preferably sends a command for aligning the second transport chassis 1′ to the second transport chassis 1′. The operating device 21 sends in particular the command for aligning the second transport chassis 1′ to the second transport chassis 1′ until the second transport chassis 1′is aligned.

In a further exemplary embodiment, the operating system can also be understood in the broadest sense as a computer on which an app, i.e. application software, is stored. One or more of the control options described above for remote control, such as selection of driving manoeuvres and the like, can be selected via the application software. Computers are understood as personal computers (PCs), but also mobile computers such as smartphones, tablets, and the like. The computer expediently comprises a radio module with which a wireless connection for data transmission from and to the transport chassis 1, 1′ can be established.

Preferably, the transport system 17 for transporting a load is configured to carry out a method described herein. Preferably, the driven transport chassis 1, 1′ is provided for the transport system 17 described herein. Preferably, the driven transport chassis 1, 1′ is provided for carrying out a method described herein.

### List of Reference Numerals

1 transport chassis
2 frame
3 longitudinal member
4 longitudinal member
5 cross member
6 drive unit
7 drive unit
8 drive roller
9 electric motor
10 load roller
11 turntable
12 load
13 axis of rotation
14 control system
15 communication unit
16 rotary encoder
17 transport system
18 rotary chassis
19 support plate
20 load rollers
21 operating device
22 direction of travel
23 straight-ahead travel direction
24 status indicator
25 pivot point

1. Method for transporting a load (12) with a transport system (17) comprising a first driven transport chassis (1) and a second driven transport chassis (1′), with the following method steps:
transporting the load (12) with the transport system (17) in a first driving manoeuvre, wherein in the first driving manoeuvre the second transport chassis (1′) follows the first transport chassis (1),
ending the first driving manoeuvre and switching to a second driving manoeuvre,
aligning the second transport chassis (1′), wherein the second transport chassis (1′) is automatically positioned relative to the first transport chassis (1),
transporting the load (12) with the transport system (17) in the second driving manoeuvre, wherein in the second driving manoeuvre the second transport chassis (1′) follows the first transport chassis (1).

2. Method according to claim 1, characterized in that the second transport chassis (1′) provides feedback on the complete alignment after the second transport chassis (1′) has completely aligned itself relative to the first transport chassis (1).

3. Method according to claim 1 or 2, characterized in that the second transport chassis (1′) provides feedback on the incomplete alignment after the second transport chassis (1′) has incompletely aligned itself relative to the first transport chassis (1) and/or while the second transport chassis (1′) is aligning itself relative to the first transport chassis (1).

4. Method according to claim 1, characterized in that before the first driving manoeuvre the second transport chassis (1′) is aligned relative to the first transport chassis (1), in particular manually, that after the alignment, in particular manual alignment, a straight-ahead travel, in particular with the load (12), is carried out, and that when the two transport chassis (1, 1′) are not travelling parallel, the second transport chassis (1′) is aligned relative to the first transport chassis (1′), in particular aligns itself until both transport chassis (1, 1′) are travelling parallel.

5. Method according to claim 1, characterized in that the first transport chassis (1) comprises a frame (2) and a turntable (11) operatively connected to the frame (2), that the turntable (11) is provided for supporting the load (12) to be transported, that the turntable (11) is rotatable relative to the frame (2), that the first transport chassis (1) comprises a rotary encoder (16), that the rotary encoder (16) detects the angle of rotation and/or the change in the angle of rotation of the turntable (11) relative to the frame (2), and/or that the second transport chassis (1′) comprises a frame (2′) and a turntable (11′) operatively connected to the frame (2′), that the turntable (11′) is provided for supporting the load (12) to be transported, that the turntable (11′) is rotatable relative to the frame (2′), that the second transport chassis (1′) comprises a rotary encoder (16′), that the rotary encoder (16′) detects the angle of rotation and/or the change in the angle of rotation of the turntable (11′) relative to the frame (2′), and that the angle of rotation of the first transport chassis (1) and/or the second transport chassis (1′) and/or that the change in the angle of rotation of the first transport chassis (1) and/or the second transport chassis (1′) is used to align the second transport chassis (1′).

6. Method according to claim 1, characterized in that the first transport chassis (1) communicates wirelessly with the second transport chassis (1′).

7. Method according to claim 1, characterized in that the transport system (17) comprises an operating device (21), in particular a remote control, and that the first transport chassis (1) and/or the second transport chassis (1′) can be operated via the operating device (21).

8. Method according to claim 7, characterized in that the second transport chassis (1′) informs the operating device (21) whether the second transport chassis (1′) has fully aligned itself relative to the first transport chassis (1), and/or whether the second transport chassis (1′) has incompletely aligned itself relative to the first transport chassis (1), and/or whether the second transport chassis (1′) is aligning itself relative to the first transport chassis (1), and in particular that the operating device (21) outputs the message to an operator.

9. Method according to claim 1, characterized in that the transport system (17) comprises a first operating device (21), in particular a first remote control, for the first transport chassis (1) and a second operating device (21), in particular a second remote control, for the second transport chassis (1′), and in that the first operating device (21) communicates with the second operating device (21), in particular wirelessly.

10. Method according to one of claims 7 to 9, characterized in that the operating device (21) sends a command for aligning the second transport chassis (1′) to the second transport chassis (1′).

11. Method according to claim 10, characterized in that the operating device (21) sends the command for aligning the second transport chassis (1′) to the second transport chassis (1′) until the second transport chassis (1′) is aligned.

12. Method according to claim 1, characterized in that the transport system (17) comprises a third driven transport chassis (1, 1′), with the following method steps:
transporting the load (12) with the transport system (17) in a first driving manoeuvre, wherein in the first driving manoeuvre the second transport chassis (1′) and the third transport chassis (1, 1′) follow the first transport chassis (1),
ending the first driving manoeuvre and switching to a second driving manoeuvre,
aligning the second transport chassis (1′) and the third transport chassis (1, 1′), wherein the second transport chassis (1′) and the third transport chassis (1, 1′) are automatically positioned relative to the first transport chassis (1),
transporting the load (12) with the transport system (17) in the second driving manoeuvre, wherein in the second driving manoeuvre the second transport chassis (1′) and the third transport chassis (1, 1′) follow the first transport chassis (1).

13. Method according to claim 1, characterized in that the transport chassis (1, 1′) have the same overall height.

14. Transport system for transporting a load (12), which is designed to carry out a method according to one of claims 1 to 13.

15. Driven transport chassis (1, 1′) for a transport system (17) according to claim 14 and/or driven transport chassis (1, 1′) which is provided for carrying out a method according to one of claims 1 to 13.
